(19) United States
(12) Patent Application Publication
(10) Pub. No.: US 2018/0087555 A1
(43) Pub. Date: Mar. 29, 2018

(54) SYSTEM, METHOD AND APPARATUS FOR FASTENING COMPONENTS

(71) Applicant: GENERAL ELECTRIC COMPANY, SCHENECTADY, NY (US)

(72) Inventors: STEVEN OWENS, MCKEAN, PA (US); DENNIS RICHTER, FAIRVIEW, PA (US); GREGORY TARBELL, ERIE, PA (US); GREGORY HECKER, ERIE, PA (US)

(73) Assignee: GENERAL ELECTRIC COMPANY, SCHENECTADY, NY (US)

(21) Appl. No.: 15/277,571

(22) Filed: Sep. 27, 2016

(51) Int. Cl. F16B 33/02

(52) U.S. Cl. CPC F16B 33/02; F16B 2033/025

(57) ABSTRACT

A fastener includes a head, a shank extending from the head, a first threaded portion having a plurality of first threads formed on the shank adjacent to the head, and a second threaded portion having a plurality of second threads formed on the shank distal from the head. The plurality of first threads have a handedness that is different from a handedness of the plurality of second threads.

### BACKGROUND

### Technical Field

Embodiments of the invention relate generally to fasteners. Certain embodiments relate to systems, methods and apparatus for fastening components where physical access to only one side of a fastener is possible.

### Discussion of Art

In many industrial assemblies, including those of off-highway vehicles (“OHVs”) and their wheel motor drives, bolted connections are required in areas where, at the time of final assembly, access to one side of the bolt or fastener is physically obstructed or restricted. This necessitates the ability to apply torque to the joint with physical access to only one side of the fastener.

Existing methods of applying torque to a connection where physical access to only one side of a bolt is available include the use of knurling on a section of the fastener that is press fit into the connection members. While the use of knurling press fit into the connection members works to react installation torque and disassembly torque, it requires the additional use of pressing tools for both assembly and disassembly. This results in added inconvenience and cost, and requires the necessary tooling to be present on site. Moreover, this method may only be employed as a one-time use, for both the fastener and the component into which the knurled section of the fastener has been press fit.

Another method involves the use of a fastener having a head of non-cylindrical shape that is received in a flange hole cut or formed to a corresponding shape such that engagement of the fastener head within the flange hole prevents rotation of the fastener. This method requires potentially non-standard head shapes and non-standard tooling in order to create the corresponding hole in the mating joint component that receives the fastener head, which can increase both cost and assembly time. Additionally, this method does not axially constrain the fastener, and can result in difficulties during disassembly.

In view of the above, there may be a need for a system, method and apparatus for fastening components where physical access to only one side of a fastener is available, which differ from those systems and methods that are currently available.

### BRIEF DESCRIPTION

In an embodiment, a fastener includes a head and an elongate shaft extending from the head and having a first end and a second end; the first end is attached to the head. The fastener also includes a first threaded portion having a plurality of first threads formed on the first end of the shaft adjacent to the head, and a second threaded portion having a plurality of second threads formed on the second end of the shaft distal from the head. The head defines a first terminus of the fastener and the second threaded portion defines a distal, second terminus of the fastener. The fastener also includes a transition portion intermediate the first threaded portion and the second threaded portion, wherein the transition portion is devoid of threads. The plurality of first threads have a handedness that is different from a handedness of the plurality of second threads, such that the plurality of first threads are left-handed threads or right-handed threads and the plurality of second threads are the other of the left-handed threads or the right-handed threads. The first threaded portion has a diameter that is greater than a diameter of the second threaded portion.

In an embodiment, a fastener includes a head, a shank extending from the head, a first threaded portion having a plurality of first threads formed on the shank adjacent to the head, and a second threaded portion having a plurality of second threads formed on the shank distal from the head. The plurality of first threads have a handedness that is different from a handedness of the plurality of second threads.

In another embodiment, a method for fastening components is provided. The method includes the steps of inserting a fastener through a first throughbore in a first component, the fastener having a head, a shank extending from the head, a first threaded portion having a plurality of first threads formed on the shank adjacent to the head, and a second threaded portion having a plurality of second threads formed on the shank distal from the head, rotating the fastener in a first direction such that the first threads of the first threaded portion engage corresponding threads within the first throughbore, passing a distal end of the fastener through a second throughbore of a second component until the distal end protrudes beyond a face of the second component, inserting a nut on the distal end of the fastener, and rotating the nut in the first direction to fasten the first component to the second component.

In another embodiment, a fastening system includes a first component having a first threaded throughbore, a second component having a second throughbore, the first threaded throughbore and the second throughbore being generally aligned with one another, and a fastener received through the first threaded throughbore and the second throughbore. The fastener includes a head, a shank extending from the head, a first threaded portion having a plurality of first threads formed on the shank adjacent to the head, and a second threaded portion having a plurality of second threads formed on the shank distal from the head. The plurality of first threads are received by corresponding threads of the first threaded throughbore. The second threaded portion protrudes from the second throughbore and receives a nut. The plurality of first threads have a handedness that is different from a handedness of the plurality of second threads.

### DRAWINGS

The present invention will be better understood from reading the following description of non-limiting embodiments, with reference to the attached drawings, wherein below:

FIG. 1 is side elevational view of a fastener for fastening components according to an embodiment of the invention.

FIG. 2 is a side elevational view of the fastener of FIG. 1, in cross section, shown fastening two components to one another.

### DETAILED DESCRIPTION

Reference will be made below in detail to exemplary embodiments of the invention, examples of which are illustrated in the accompanying drawings. Wherever possible, the same reference characters used throughout the drawings refer to the same or like parts. As used herein, “mechanically coupled” refers to any coupling method capable of supporting the necessary forces for transmitting torque between components. As used herein, “operatively coupled” refers to a connection, which may be direct or indirect. The connection is not necessarily being a mechanical attachment.

Embodiments of the invention relate generally to fastener for fastening components to one another where, at the time of final assembly, access to one side of the bolt or fastener is physically obstructed or restricted. In one embodiment, a fastener includes a head, a shank extending from the head, a first threaded portion having a plurality of first threads formed on the shank adjacent to the head, and a second threaded portion having a plurality of second threads formed on the shank distal from the head. The plurality of first threads have a handedness that is different from a handedness of the plurality of second threads. In particular, the plurality of first threads may be left-handed threads and the plurality of second threads may be right-handed threads.

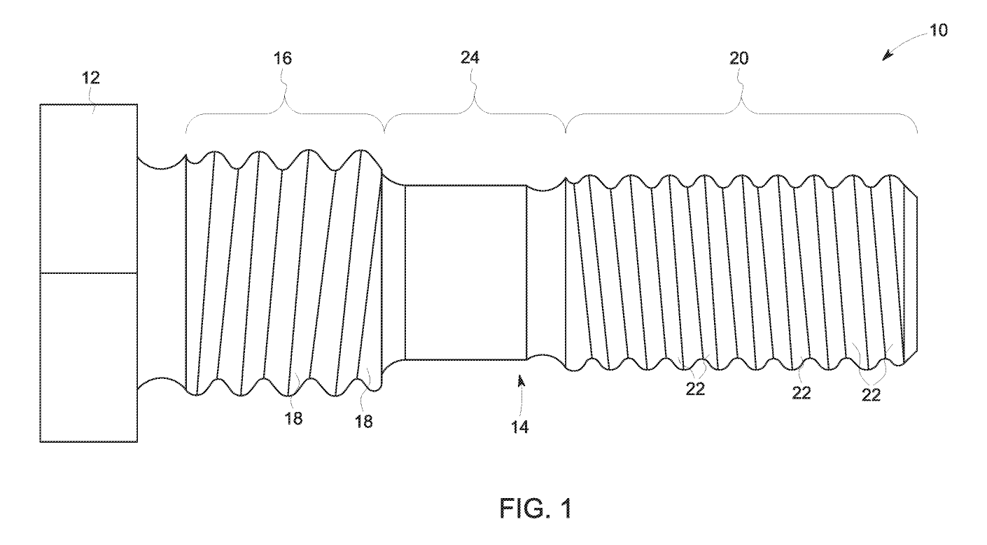

FIG. 1 shows a fastener 10 according to an embodiment of the invention. The fastener 10 generally takes the form of a bolt and includes a head 12 and a body portion or shank 14 extending from the head 12. The head 12 may take various shapes including hexagonal, domed, 12-point or other configuration. The shank 14 includes a first threaded portion 16 having a plurality of first threads 18 adjacent to the head 12, and a second threaded portion 20 having a plurality of second threads 22 distal from the head 12. As shown in FIG. 1, the first threaded portion 16 may be separated from the second threaded portion 20 by a transition portion 24 that is devoid of threads. The transition portion 24 may be a uniform diameter throughout its longitudinal extent. In other embodiments, the transition portion 24 may having varying diameter sections.

In an embodiment, the first threads 18 of the first threaded portion 16 have a handedness that is the opposite of the second threads 22 of the second threaded. portion 20. For example, in an embodiment, the first threads 18 of the first threaded portion 16 are left-handed threads while the second threads 22 of the second threaded portion 20 are right-handed threads. In other embodiments, the first threads 18 of the first threaded portion 16 may be right-handed threads while the second threads 22 of the second threaded portion 20 may left-handed threads.

As further illustrated in FIG. 1, in an embodiment, the outside diameter of the first threaded portion 16 is greater than the outside diameter of the second threaded portion 20. The second threads 22 of the second threaded portion 20 are configured to receive a correspondingly sized and threaded nut, as discussed in detail hereinafter. The internal, female threads of the nut have a handedness that is the same as the handedness of the second threads 22.

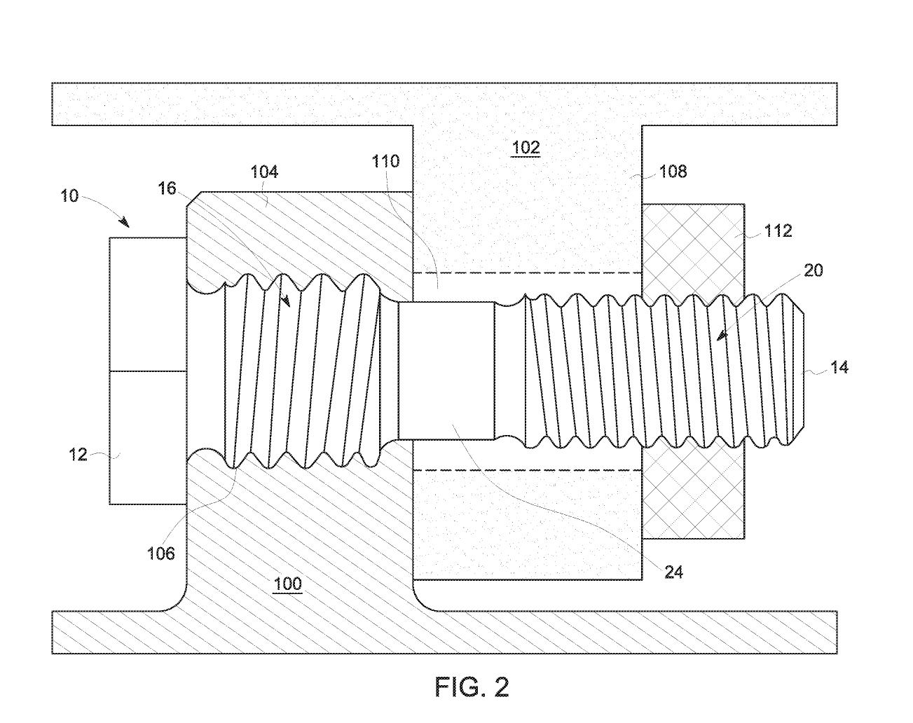

Referring now to FIG. 2, use of the fastener 10 to joint two components 100, 102 where a head 12 of the fastener 12 is not accessible during final installation is shown. As illustrated therein, the first component 100 includes a flange 104 having a first throughbore 106 formed therethrough, and the second component 102 includes a flange 108 having a second throughbore 110 formed therethrough. In an embodiment, the first throughbore 106 is a threaded bore having a plurality of female threads configured to threadedly receive the threads 18 of the first threaded portion 16 of the fastener 10.

During assembly, the first and second components 100, 102 are brought into registration with one another so that the respective throughbores 106, 110 are aligned. The fastener 10 may then be inserted through the throughbores 106, 110. In other embodiments, the fastener 10 may first be inserted into the throughbore 106 in the flange 104 of the first component 100 and rotated to retain the fastener 10 in the threaded bore 106 of the first component, prior to registering the second component 102 with the first component. In particular, because the second threaded portion 20 of the fastener 10 has a diameter that is less than the diameter of the first threaded portion 16, the second threaded portion 20 may pass through the threaded bore 106 of the first component axially, without engaging the threads of the bore 106. Once the second threaded portion 20 extends through the bore 106, the fastener 10 may be rotated to engage the threads 18 of the first threaded portion 16 with the female threads of the throughbore 106, as discussed above. Once retained in place, the second component 102 may be brought into registration with the first component 100 such that the distal end of the fastener 10 protrudes from the throughbore 110 of the second component, so that nut 112 may be installed.

As shown in FIG. 2, once the first and second components 100, 102 are aligned, the head 12 of the fastener 10 may not be physically accessible, which would typically be necessary to securely join the components using a nut on the distal end of the fastener. For example, one of the components (or other components) may impede or restrict access to the head 12 of the fastener 10, preventing it from being held in place as the nut is threaded on the end of the fastener. In order to secure the components 100, 102 to one another, a nut 112, having female threads (not shown) that correspond to the plurality of second threads 22 of the second threaded portion 20 of the fastener 10 is threaded onto the distal end of the fastener 10. In an embodiment, the nut 112 has right-handed threads that correspond to the right-handed threads of the second portion 20, and which are the opposite of the left-handed threads of the first portion 16. In other embodiments, the nut 112 may have left-handed threads that correspond to left-handed threads of the second portion 20, and which are the opposite of right-handed threads of the first portion 16. In any implementation, the handedness of the threads of the nut 112 and second portion 20 of the fastener 10 is the opposite of the threads 18 of the first portion 16 of the fastener 10.

As the nut 112 is threaded onto the second portion 20 of the fastener 10, tightening rotation of the nut 112 mechanically forces the larger diameter, opposite threaded first portion 16 of the fastener to react the torque of installation applied to the smaller diameter, section portion 20. This is because, due to the opposite-handedness of the threads, each must mechanically rotate in the same direction under the application of torque. This functions to tighten the joint between the components 100, 102 with a single tool (e.g., a wrench or socket) used only at the free, distal end of the fastener 10. In particular, rotation of the nut 112 on the second portion 20 will pull the components 100, 102 together until the head 12 of the fastener 10 contacts the face of the flange 104. At this point, the larger diameter first portion 16 cannot he physically threaded further without simultaneously providing a reacting torque for the torque applied to the smaller diameter section portion 20. This allows final torque on the joint to be achieved.

In particular, as the nut is threaded onto the distal end of the fastener 10, any rotation imparted to the fastener 10 is actually in the installation (tightening) direction of the fastener 10 (i.e., advancing it further within the threaded bore 106) due to the second threads 22 being opposite handed from the first threads 18. This is in contrast to typical fasteners, whereby threading a nut on the distal end of the fastener would impart a loosening rotation to the fastener, preventing a tight joint between components from being established. Accordingly, a torqued connection between components may be achieved at a level heretofore not seen in the art. In addition, in contrast to existing fasteners, safe disassembly may be achieved using the same tooling used for installation, such as a torque wrench or gun (i.e., without requiring any special tools). The fastener and joined components may therefore also be reused, which is often not possible with existing press fit and related methods. Moreover, utilizing the fastener 10 allows standard manufacturing tooling to be used in the joined components themselves, without requiring any custom milling or shaping to he performed to accommodate a special fastener.

In an embodiment, a fastener includes a head and an elongate shaft extending from the head and having a first end and a second end; the first end is attached to the head. The fastener also includes a first threaded portion (of the shaft) having a plurality of first threads formed on the first end of the shaft adjacent to the head, and a second threaded portion (of the shaft) having a plurality of second threads formed on the second end of the shaft distal from the head. The head defines a first terminus of the fastener and the second threaded portion defining a distal, second terminus of the fastener, i.e., in this embodiment, there is no portion of the fastener past the head or second threaded portion. The fastener also includes a transition portion (of the shaft) intermediate the first threaded portion and the second threaded portion, wherein the transition portion is devoid of threads. The plurality of first threads have a handedness that is different from a handedness of the plurality of second threads, such that the plurality of first threads are left-handed threads or right-handed threads and the plurality of second threads are the other of the left-handed threads or the right-handed threads. (I.e., one portion is left-handed and the other is right-handed.) The first threaded portion has a diameter that is greater than a diameter of the second threaded portion.

In an embodiment, a fastener is provided. The fastener includes a head, a shank extending from the head, a first threaded portion having a plurality of first threads formed on the shank adjacent to the head, and a second threaded portion having a plurality of second threads formed on the shank distal from the head. The plurality of first threads have a handedness that is different from a handedness of the plurality of second threads. In an embodiment, the plurality of first threads are left-handed threads, and the plurality of second threads are right-handed threads. In another embodiment, the plurality of first threads are right-handed threads, and the plurality of second threads are left-handed threads. In an embodiment, the first threaded portion has a diameter that is greater than a diameter of the second threaded portion. In an embodiment, the fastener may further include a transition portion intermediate the first threaded portion and the second threaded portion. In an embodiment, the transition portion may be devoid of threads. In an embodiment, the head is one of a hexagonal head, domed head or 12-point head.

In another embodiment, a method for fastening components is provided. The method includes the steps of inserting a fastener through a first throughbore in a first component, the fastener having a head, a shank extending from the head, a first threaded portion having a plurality of first threads formed on the shank adjacent to the head, and a second threaded portion having a plurality of second threads formed on the shank distal from the head, rotating the fastener in a first direction such that the first threads of the first threaded portion engage corresponding threads within the first throughbore, passing a distal end of the fastener through a second throughbore of a second component until the distal end protrudes beyond a face of the second component, inserting a nut on the distal end of the fastener, and rotating the nut in the first direction to fasten the first component to the second component. In an embodiment, the plurality of first threads are left-handed threads, and the plurality of second threads are right-handed threads. In another embodiment, the plurality of first threads are right-handed threads, and the plurality of second threads are left-handed threads. In an embodiment, the step of inserting the fastener through the first throughbore of the first component includes axially passing the second threaded portion of the fastener past the threads within the first throughbore without the second plurality of threads of the second threaded portion engaging the threads of the first throughbore. In an embodiment, the first threaded portion has a diameter that is greater than a diameter of the second threaded portion. In an embodiment, the fastener includes a transition portion intermediate the first threaded portion and the second threaded portion. In an embodiment, the transition portion is devoid of threads. In an embodiment, the head is one of a hexagonal head, domed head or 12-point head.

In yet another embodiment, a fastening system is provided. The fastening system includes a first component having a first threaded throughbore, a second component having a second throughbore, the first threaded throughbore and the second throughbore being generally aligned with one another, and a fastener received through the first threaded throughbore and the second throughbore, the fastener including a head, a shank extending from the head, a first threaded portion having a plurality of first threads formed on the shank adjacent to the head, and a second threaded portion having a plurality of second threads formed on the shank distal from the head. The plurality of first threads are received by corresponding threads of the first threaded throughbore. The second threaded portion protrudes from the second throughbore and receives a nut. The plurality of first threads have a handedness that is different from a handedness of the plurality of second threads. In an embodiment, the plurality of first threads are left-handed threads, and the plurality of second threads are right-handed threads. In an embodiment, the plurality of first threads are right-handed threads, and the plurality of second threads are left-handed threads. In an embodiment, the first threaded portion has a diameter that is greater than a diameter of the second threaded portion. In an embodiment, the fastener includes a transition portion intermediate the first threaded portion and the second threaded portion. In an embodiment, the transition portion is devoid of threads.

Reference will be made below in detail to exemplary embodiments of the invention, examples of which are illustrated in the accompanying drawings. Wherever possible, the same reference characters used throughout the drawings refer to the same or like parts. While embodiments of the invention are suitable for use with both mobile and stationary implementations, for ease of explanation a mobile implementation is described in detail herein. More specifically, an OHV has been selected for clarity of illustration for the disclosure of mobile embodiments. Other suitable vehicles include, for example, on-road vehicles, locomotives, construction equipment, industrial equipment, and marine vessels. As used herein, “electrical communication” or “electrically coupled” means that certain components are configured to communicate with one another through direct or indirect signaling by way of direct or indirect electrical connections. As used herein, “mechanically coupled” refers to any coupling method capable of supporting the necessary forces for transmitting torque between components. As used herein, “operatively coupled” refers to a connection, which may be direct or indirect. The connection is not necessarily being a mechanical attachment.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

This written description uses examples to disclose several embodiments of the invention, including the best mode, and also to enable one of ordinary skill in the art to practice the embodiments of invention, including making and using any devices or systems and performing any incorporated methods. The patentable scope of the invention is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

1. A fastener, comprising:
a head;
an elongate shaft extending from the head and having a first end and a second end, the first end attached to the head;
a first threaded portion having a plurality of first threads formed on the first end of the shank adjacent to the head;
a second threaded portion having a plurality of second threads formed on the second end of the shank distal from the head, the head defining a first terminus of the fastener and the second threaded portion defining a distal, second terminus of the fastener; and
a transition portion intermediate the first threaded portion and the second threaded portion, wherein the transition portion is devoid of threads;
wherein the plurality of first threads have a handedness that is different from a handedness of the plurality of second threads, the plurality of first threads being one of left-handed threads or right-handed threads and the plurality of second threads being the other of the left-handed threads or the right-handed threads; and
wherein the first threaded portion has a diameter that is greater an a diameter of the second threaded portion.

2. A fastener, comprising:
a head;
a shank extending from the head;
a first threaded portion having a plurality of first threads formed on the shank adjacent to the head; and
a second threaded portion having a plurality of second threads formed on the shank distal from the head;
wherein the plurality of first threads have a handedness that is different from a handedness of the plurality of second threads.

3. The fastener of claim 2, wherein:
the plurality of first threads are left-handed threads; and
the plurality of second threads are right-handed threads.

4. The fastener of claim 2, wherein:
the plurality of first threads are right-handed threads; and
the plurality of second threads are left-handed threads.

5. The fastener of claim 2, wherein:
the first threaded portion has a diameter that is greater than a diameter of the second threaded portion.

6. The fastener of claim 2, further comprising:
a transition portion intermediate the first threaded portion and the second threaded portion, wherein the transition portion is devoid of threads.

7. The fastener of claim 2, wherein:
the head is one of a hexagonal head, domed head, or 12-point head.

8-15. (canceled)

16. A fastening system, comprising:
a first component having a first threaded throughbore;
a second component having a second throughbore, the first threaded throughbore and the second throughbore being generally aligned with one another; and
a fastener received through the first threaded throughbore and the second throughbore, the fastener including a head, a shank extending from the head, a first threaded portion having a plurality of first threads formed on the shank adjacent to the head, and a second threaded portion having a plurality of second threads formed on the shank distal from the head;
wherein the plurality of first threads are received by corresponding threads of the first threaded throughbore;
wherein the second threaded portion protrudes from the second throughbore and receives a nut; and
wherein the plurality of first threads have a handedness that is different from a handedness of the plurality of second threads.

17. The fastening system of claim 16, wherein:
the plurality of first threads are left-handed threads; and
the plurality of second threads are right-handed threads.

18. The fastening system of claim 16, wherein:
the plurality of first threads are right-handed threads; and
the plurality of second threads are left-handed threads.

19. The fastening system of claim 16, wherein:
the first threaded portion has a diameter that is greater than a diameter of the second threaded portion.

20. The fastening system of claim 16, further comprising:
a transition portion intermediate the first threaded portion and the second threaded portion, wherein the transition portion is devoid of threads.
